(19) United States
(12) Patent Application Publication
(10) Pub. No.: US 2010/0124275 A1
(43) Pub. Date: May 20, 2010

(54) SYSTEM AND METHOD FOR DYNAMICALLY ENCODING MULTIMEDIA STREAMS

(75) Inventors: Ping-Cheng Yeh, Taipei (TW); Hung-Yun Hsieh, Taipei (TW)

Correspondence Address: EDWARDS ANGELL PALMER & DODGE LLP, P.O. BOX 55874, BOSTON, MA, 02205, US

(73) Assignee: NATIONAL TAIWAN UNIVERSITY, Taipei (TW)

(21) Appl. No.: 12/408,105

(22) Filed: Mar. 20, 2009

(30) Foreign Application Priority Data
Nov. 18, 2008 (TW) 097144452

(51) Int. Cl. H04N 11/02

(52) U.S. Cl. 375/240.07; 375/E07.126

(57) ABSTRACT

A system and method for dynamically encoding multimedia streams is provided. A user-end device is allowed to generate a network status message and transmit it to a data server, and the data server dynamically adjusts encoding parameters based on the network status message, encodes multimedia data using the adjusted encoding parameters, and sends the encoded multimedia data to the user-end device. This system and method solves problems where the picture quality and playback smoothness are affected by packets loss or error at the user end due to inability to adapt to constantly changing network conditions as in the prior art.

### FIELD OF THE INVENTION

The present invention relates to a system and method for dynamically encoding multimedia streams, and more particularly, to a system and method for dynamically encoding multimedia streams that adjusts encoding parameters through feedback and adaptive processing mechanisms.

### BACKGROUND OF THE INVENTION

As the broadband technology develops, multimedia streaming has become one of the most popular internet services over the years. A typical multimedia streaming service generally consists of a video server which encodes (i.e. compresses) multimedia contents using video codec and transmits the encoded data to users in real-time. Multimedia streaming can be applied to many applications. One growing demand nowadays is to apply multimedia streaming service for mobile TV services, with which the TV program can be streamed by some home server to a user whenever he/she has internet connections.

Prior-art multimedia streaming usually involves the video server using predetermined encoding parameters for the encoding, that is, compression, of the multimedia data. Note that such multimedia data compression is necessary since the network bandwidth limit is significantly smaller than the raw data rate of the multimedia contents. However, conventional multimedia streaming has several drawbacks.
(1) The fluctuating network condition often degrades the quality of service (QoS). Generally, a network is shared by many users. When many people send out packets at the same time, the heavy load results in either large packet delay or high packet loss rate. This severely affects the decoding of the multimedia streaming and thus the playback quality.
(2) Users can only passively receive data. Since prior art provides no user feedback mechanism, the server cannot adjust its encoding parameters in real time, thus poor video picture are constantly received at the user ends.

Accordingly, there is a need for a method and system for multimedia streaming that solves the abovementioned problems. Such method and system would allow the multimedia servers to dynamically adjust the encoding parameters according to the feedbacks from the users.

### SUMMARY OF THE INVENTION

In the light of forgoing drawbacks, the present invention is to provide a system and method for dynamically encoding multimedia streams that uses feedback and adaptive processing mechanisms to allow a server to dynamically adjust encoding parameters, thereby improving video quality at a user end.

The present invention provides a system and method for dynamically encoding multimedia streams, including: a user-end device; and a data server for providing multimedia data to the user-end device over the network, wherein the user-end device generates the network status message and sends it to the data server, which then dynamically adjusts encoding parameters based on the network status message, encodes the multimedia data using the encoding parameters, and sends the encoded multimedia data to the user-end device. In another embodiment of the present invention, the user-end device does not send the network status message to the data server, but adjusts the encoding parameters based on the network status message. After the encoding parameters are adjusted, the user-end device sends the adjusted encoding parameters to the data server, which then encodes the multimedia data with the adjusted encoding parameters.

In a preferred aspect, the user-end device further includes: a network monitoring module for monitoring and analyzing network statuses and generating the network status message; and a data decoding module for decoding the encoded multimedia data, and the data server includes: an adaptive processing module for dynamically adjusting the encoding parameters based on the network status message; and a data encoding module for encoding the multimedia data using the adjusted encoding parameters.

The present invention also provides a system for dynamically encoding multimedia streams applicable in a network, comprising: a user-end device; and a data server for providing multimedia data to the user-end device over the network, wherein the user-end device generates a network status message, dynamically adjusts encoding parameters through a learning mechanism, and sends the encoding parameters to the data server, which then encodes the multimedia data using the encoding parameters and sends the encoded multimedia data to the user-end device.

In a preferred aspect, the user-end device further includes: a network monitoring module for monitoring and analyzing the network statuses and generating the network status message; a learning module for performing a learning algorithm on the network status message to obtain the encoding parameters; and a data decoding module for decoding the encoded multimedia data.

The present invention also provides a method for dynamically encoding multimedia streams applicable in a network, comprising the following steps of: (1) allowing a user-end device to generate a network status message and transmitting the network status message to a data server; (2) allowing the data server to dynamically adjust encoding parameters based on the network status message; (3) allowing the data server to encode multimedia data using the encoding parameters; and (4) allowing the data server to transmit the encoded multimedia data to the user-end device for decoding thereat.

The present invention also provides a method for dynamically encoding multimedia streams applicable in a network, comprising: (1) allowing a user-end device to generate a network status message; (2) allowing the user-end device to dynamically adjust encoding parameters through a learning mechanism, and send the encoding parameters to a data server; (3) allowing the data server to encode multimedia data using the encoding parameters; and (4) allowing the data server to send the encoded multimedia data to the user-end device for decoding thereat.

In comparison to the prior-art techniques, the system and method for dynamically encoding multimedia streams allows the user-end device to feedback the network status message to the data server, so that the data server can perform adaptive adjustment on encoding parameters, thereby solving problems that picture quality and playback smoothness are affected by packets lost or error at the user end due to unable to adapt to constantly changing network statuses as described in the prior art.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram depicting the basic structure of a system for dynamically encoding multimedia streams according to the present invention;

FIG. 2 is a diagram depicting an embodiment of the system for dynamically encoding multimedia streams according to the present invention;

FIG. 3 is a diagram depicting another embodiment of the system for dynamically encoding multimedia streams according to the present invention;

FIG. 4 is a diagram depicting actual applications of the system for dynamically encoding multimedia streams according to the present invention;

FIG. 5 is a flowchart illustrating an embodiment of a method for dynamically encoding multimedia streams according to the present invention;

FIG. 6 is a flowchart illustrating another embodiment of the method for dynamically encoding multimedia streams according to the present invention; and

FIG. 7 is a diagram depicting a cross-module communication mechanism in the method for dynamically encoding multimedia streams according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

Referring to FIG. 1, a schematic diagram depicting a system for dynamically encoding multimedia streams according to an embodiment of the present invention is shown. The system for dynamically encoding multimedia streams includes a network system 11, a data server 12, and a user-end device 13.

The user-end device 10 can be electronics for accessing and processing data, such as a desktop computer, a laptop computer, a digital TV, a personal digital assistance (PDA) and/or a mobile phone.

The network system 11 can be a media for digital data transmission for transmitting data between various data processing apparatuses. In the present invention, the network system 11 can be a wired network system and/or wireless network system. For example, Internet, Local Area Network (LAN), Wide Area Network (WAN) and/or Virtual Private Network (VPN).

In actual implementation, the user-end device 10 generates network status message and sends this message to the data server 12 over the network system 11. The data server 12 then adjusts its encoding parameters according to the network status message and encodes multimedia data based on the adjusted parameters; afterwards, it sends the encoded multimedia data to the user-end device 10. In such a way, when the network at which the user-end device resides degrades, the data server 12 is informed through such feedback mechanism. The data server 12 may dynamically adjust the encoding parameters, so that when the user at the user end receives video data, frame quality and playback smoothness of the video stream can be maintained by the system of the present invention.

In one preferred embodiment, there are various encoding formats for multimedia data, including, for example, MPEG-1, MPEG-2, MPEG-4, WMV, AVI, H.261, H.263, H.264, Y4M and/or YUV. The encoding parameters may be quantization, group of picture size, frame size and/or picture size, for example.

In yet another preferred embodiment, the user-end device 10 sends message back to the data server 12 through the so-called Real-Time Control Protocol (RTCP) feedback mechanism.

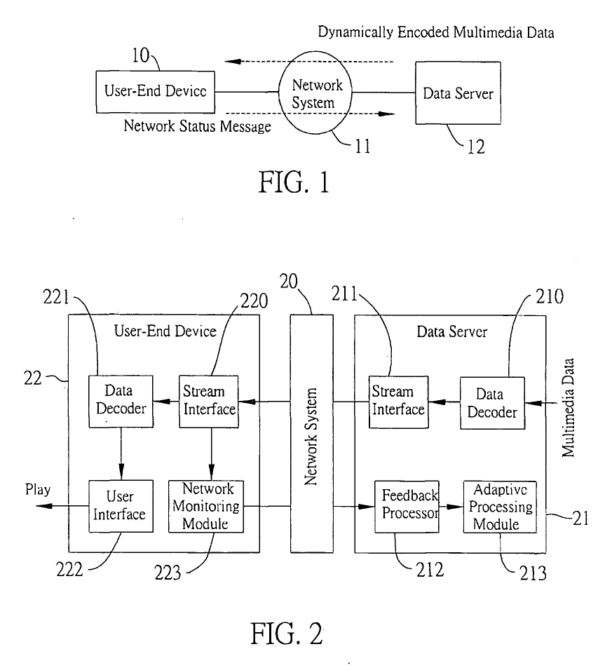

Referring to FIG. 2, an embodiment of the system for dynamically encoding multimedia streams is shown. This embodiment includes a network system 20, a data server 21 and a user-end device 22. In comparison to FIG. 1, the data server 21 of this embodiment further includes a data encoder 210, a stream interface 211, a feedback processor 212 and an adaptive processing module 213. The adaptive processing module 213 dynamically adjusts the encoding parameters based on the network status message. The data encoder 210 encodes the multimedia data after the encoding parameters are adjusted. On the other hand, the user-end device 22 further includes a stream interface 220, a data decoder 221, a user interface 222 and a network monitoring module 223. The network monitoring module 223 is used for generating the network status message by monitoring and analyzing network statuses, such as the network bandwidth, bandwidth fluctuation rate, packet loss rate, packet delay, delay jitter, bit error rate, receiving signal strength indication (RSSI) and/or throughput of the wired/wireless network channels. The data decoder 221 decodes the encoded multimedia data.

In actual implementation, there are two scenarios. In one scenario, the data server 21 receives multimedia data and transmits it to the data encoder 210, which encodes (compresses) the data with preset encoding parameters. Then, the encoded data packets are sent from the stream interface 211 to the stream interface 220 of the user-end device 22. The user-end device 22, on one hand, sends the data packets to the data decoder 221 for decompression and to be played by the user interface 222, on the other hand, monitors and generates the network status message on network bandwidth, bandwidth fluctuation rate, packet loss rate, packet delay, delay jitter, bit error rate, or etc., through the network monitoring module 223. This message is sent back to the feedback processor 212 of the data server 21, which then sends it to the adaptive processing module 213 for determination. If the adaptive processing module 213 determines that the encoding parameters corresponding to the previous network status are the same with those corresponding to the current network status, the original encoding parameters remain unchanged, i.e. which are still used for data encoding.

In the second scenario, when abnormality occurs in the network status of the user-end device 22, the adaptive processing module 213 determines that the current encoding parameters should be adjusted from the previous values; it then immediately informs the data encoder 210 with the adjusted values of the encoding parameters. The effect of the network fluctuations on multimedia streaming can thus be minimized.

In a preferred embodiment, the adaptive processing module 213 can establish a parameter adjustment table in advance, so that when a network status message is received, it can look up the table to obtain the encoding parameters corresponding to the network status message. For example, the considered encoding parameters are the quantization value (hereinafter QP) and the group of picture size (hereinafter GOP size). Then, a MPEG-4 encoder is used for data compression. Usually, the QP is preferably in the range 0-31, the GOP size in the range 1-18. The following parameter adjustment table can be empirically obtained:

| | | | |
|---|---|---|---|
| Packet Lost Rate | 0~0.1 | 0.1~0.6 | 0.6~∞ |
| GOP size | 20 | 10 | 5 |
| Estimated Bandwidth | 0~1200 | 1200~4200 | 4200~∞ |
| QP | 20 | 10 | 5 |

From the above pre-established parameter adjustment table, when the adaptive processing module 213 obtains message about the packet lost rate and estimated bandwidth at user end, the appropriate encoding parameters can be easily obtained through the look-up table.

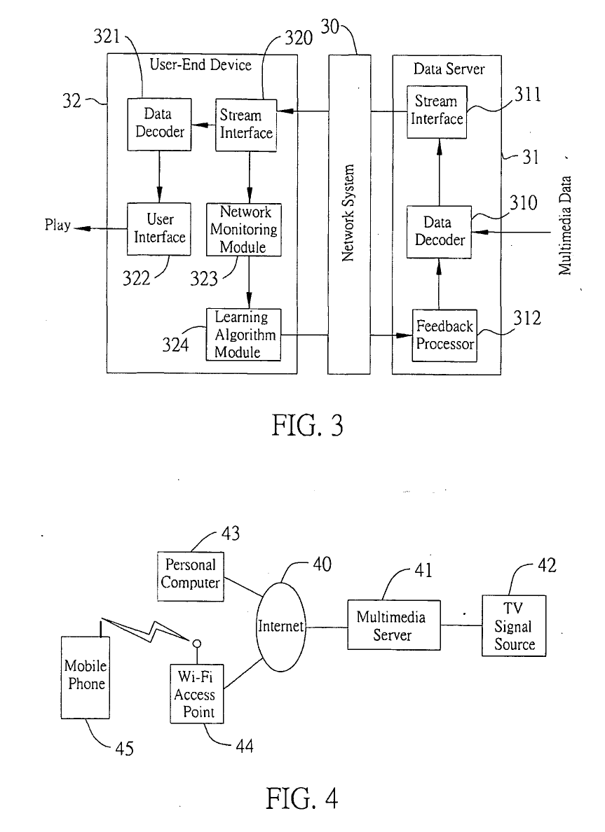

Referring to FIG. 3, another embodiment of the system for dynamically encoding multimedia streams is shown. This embodiment includes a network system 30, a data server 31 and a user-end device 32. In comparison to FIG. 2, the data server 31 of this embodiment includes a data encoder 310, a stream interface 311 and a feedback processor 312, but no adaptive processing module. On the other hand, the user-end device 22 includes a stream interface 320, a data decoder 321 and a network monitoring module 323, as well as a learning module 324, which performs learning algorithm using the network status message to obtain the encoding parameters.

In actual implementation, the data server 31 first encodes multimedia data with preset encoding parameters by the data encoder 310. Then, the encoded data packets are sent from the stream interface 311 to the stream interface 320 of the user-end device 32. The user-end device 32, on one hand, sends the data packets to the data decoder 321 for decompression and to be played by the user interface 322, on the other hand, monitoring various network status messages through the network monitoring module 323. Then, the encoding parameters are dynamically adjusted using the learning mechanism provided by the learning module 324, and the adjusted encoding parameters are then sent to the feedback processor 312 of the data server 31, which then sends it to the data encoder 310 for encoding multimedia data using the updated encoding parameters. Afterwards, the encoded packets are transmitted to the user-end device 32.

One advantage of this embodiment is that the user-end device 32 has a learning mechanism that adapts to various network conditions, so that the user-end device 32 may calculate appropriate encoding parameters under different hardware/software environments, and transmits the adjusted parameters to the data server 31 for dynamically update.

Referring to FIG. 4, a schematic diagram illustrating actual applications of the system for dynamically encoding multimedia streams of the present invention is shown. This embodiment includes the Internet 40, a multimedia server 41, a TV signal source 42, a personal computer 43, a Wi-Fi access point 44 and a mobile phone 45.

For the user of the mobile phone 45, since in a wireless local network, network condition may vary greatly due to factors such as multipath fading, shadowing effect or Doppler effect, so the receiving signal strength indicator (RSSI) can be used as an indication of channel quality. In addition, the personal computer 43 under wired network infrastructure may use the above packet lost rate and bandwidth as indications of channel quality.

Firstly, the multimedia server 41 receives and compresses multimedia data from the TV signal source 42 before transmitting to the personal computer 43 and the mobile phone 45 over the Internet 40. The interference source of the mobile phone includes a wired network interference section between the Internet 40 to the Wi-Fi access point 44 and a wireless network interference section between the Wi-Fi access point 44 and the mobile phone 45. Through the adaptive dynamic encoding mechanism of the present invention, interference sources from both the wired network and wireless network are considered for calculation of the most appropriate encoding parameters.

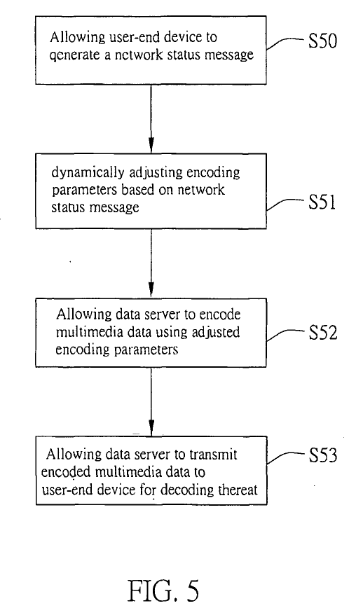

Referring to FIG. 5, a flowchart illustrating the method for dynamically encoding multimedia streams according to an embodiment of the present invention is shown, which includes the following steps.

In step S50, a network status message is generated. The network status message may be about the network bandwidth, bandwidth fluctuation rate, packet loss rate, packet delay, delay jitter, bit error rate, receiving signal strength indication (RSSI) and/or throughput traffic of the wired/wireless network channels. The user-end device may be a desktop computer, a laptop computer, a digital TV, a personal digital assistance (PDA) and/or a mobile phone. Then, proceed to step S51.

In step S51, encoding parameters are adjusted based on the network status message generated in step S50, wherein the encoding parameters may be quantization value, GOP, frame size and/or picture size. In the embodiment of the present invention, either the data server or the user end device can adjust the encoding parameters. If the encoding parameters are adjusted by the user end device, the user end device sends the adjusted encoding parameters to the server end after the execution of step S51. If the encoding parameters are adjusted by the server end, the network status message generated in step S50 are sent to the server end after the execution of step S50. Then, proceed to step S52.

In step S52, the multimedia data is encoded by the data server using the adjusted encoding parameters, in which, the encoding formats may include MPEG-1, MPEG-2, MPEG-4, WMV, AVI, H.261, H.263, H.264, Y4M and/or YUV. Then, proceed to step S52. Then, proceed to step S53.

In step S53, the encoded multimedia data is transmitted from the data server to the user-end device, at which the data is then decoded.

In a preferred embodiment, the above step S51 further includes: establishing a parameter adjustment table, so that the network status message is compared with the parameter adjustment table by the data server to obtain encoding parameters corresponding to the network status message.

In another preferred embodiment, the message can be sent back from the user-end device to the data server through the real-time control protocol (RTCP) feedback mechanism.

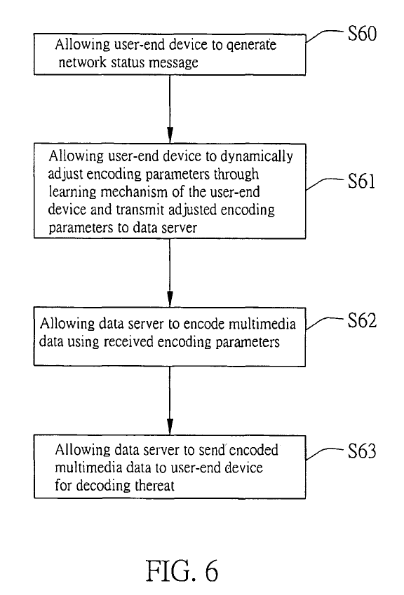

Referring to FIG. 6, a flowchart illustrating the method for dynamically encoding multimedia streams according to another embodiment of the present invention is shown, which includes the following steps.

In step S60, a network status message is generated by the user-end device. Then, proceed to step S61.

In step S61, encoding parameters are dynamically adjusted through a learning mechanism of the user-end device, and then the adjusted encoding parameters are transmitted to a data server. Then, proceed to step S62.

In step S62, multimedia data is encoded by the data server using the received encoding parameters. Then, proceed to step S63.

In step S63, the encoded multimedia data is sent to from the data server to the user-end device for decoding thereat.

In a preferred embodiment, the above step S61 further includes: establishing a learning model, which allows the user-end device to input network status message into the learning model, generate encoding parameters output by the parameter learning model, and send the encoding parameters to the data server.

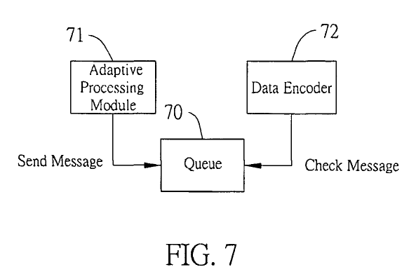

Referring to FIG. 7, a diagram depicting cross-module communication mechanism in the method for dynamically encoding multimedia data of the present invention is shown. The operational system of this cross-module communication mechanism includes a queue 70, an adaptive processing module 71 and a data encoder 72. The operations of which are essentially described as follow.

The message including encoding parameters is sent from the adaptive processing module in the data server to the queue 70. Then, a message is obtained from the queue 70 by the data encoding module 72. Finally, multimedia data is encoded by the data server using the encoded parameters in the message.

Accordingly, in the adaptive algorithm, the network status message is reported back to the data server through the feedback mechanism, and the most appropriate compression parameters are calculated by the adaptive processing module 71. Then, the compression parameters are reported to the data encoder 72 utilizing the cross-module communication mechanism, thereby completing a series of dynamic adjustment processes.

In summary, the system and method for dynamically encoding multimedia streams have the effects of:
(1) improving quality and efficiency of multimedia video transmission at the server end. The present invention employs adaptive encoding parameter adjustment mechanism, so that the server end may provide the optimally compressed data to the user based on current network status. It thus balances the frame quality and playback smoothness of the multimedia data while allowing the server end to obtain the network status at user end, thereby increasing encoding efficiency.
(2) increasing tolerance to network variation at the user end. By using the feedback and dynamic encoding mechanisms of the present invention, the user can receive video data with frame quality and playback smoothness adapted under current network environment, thereby increasing TV quality and the tolerance of the user end device to network variations.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A system for dynamically encoding multimedia streams to be transmitted in a network, comprising:
a user-end device; and
a data server for providing multimedia data to the user-end device over the network,
wherein the user-end device generates a network status message and sends it to the data server, and the data server dynamically adjusts encoding parameters based on the network status message, encodes the multimedia data using the encoding parameters, and sends the encoded multimedia data to the user-end device.

2. The system of claim 1, wherein the user-end device includes:
a network monitoring module for generating the network status message; and
a data decoding module for decoding the encoded multimedia data,
and the data server includes:
an adaptive processing module for dynamically adjusting the encoding parameters based on the network status message; and
a data encoding module for encoding the multimedia data using the adjusted encoding parameters.

3. The system of claim 2, wherein the adaptive processing module establishes a parameter adjustment table, and performs look-up in the parameter adjustment table using the received network status message to obtain the encoding parameters corresponding to the network status message.

4. The system of claim 2, wherein the network monitoring module generates the network status message by monitoring and analyzing at least one of network bandwidth, bandwidth fluctuation rate, packet loss rate, packet delay, delay jitter, bit error rate, receiving signal strength indication (RSSI) and network traffic of wired/wireless network channels.

5. The system of claim 1, wherein an encoding format for the multimedia data is MPEG-1, MPEG-2, MPEG-4, WMV, AVI, H.261, H.263, H.264, Y4M or YUV.

6. The system of claim 1, wherein the encoding parameters comprise quantization, group of picture size, frame size and frame rate.

7. The system of claim 1, wherein the user-end device sends the network status message back to the data server through a Real-Time Control Protocol (RTCP) feedback mechanism.

8. A system for dynamically encoding multimedia streams to be transmitted in a network, comprising:
a user-end device; and
a data server for providing multimedia data to the user-end device over the network,
wherein the user-end device generates a network status message, dynamically adjusts encoding parameters through a learning mechanism, and sends the encoding parameters to the data server, and the data server encodes the multimedia data using the encoding parameters and sends the encoded multimedia data to the user-end device.

9. The system of claim 8, wherein the user-end device includes:
a network monitoring module for generating the network status message;
a learning module for performing a learning algorithm on the network status message to obtain the encoding parameters; and
a data decoding module for decoding the encoded multimedia data.

10. The system of claim 9, wherein the network monitoring module generates the network status message by monitoring and analyzing at least one of network bandwidth, bandwidth fluctuation rate, packet loss rate, packet delay, delay jitter, bit error rate, receiving signal strength indication (RSSI) and network traffic of wired/wireless network channels.

11. The system of claim 8, wherein the encoding parameters comprise quantization, group of picture size, frame size and frame rate.

12. A method for dynamically encoding multimedia streams to be transmitted in a network, comprising the following steps of:
generating a network status message and transmitting the network status message to a data server by an user end device;
dynamically adjusting encoding parameters of the data server based on the network status message;
encoding multimedia data using the adjusted encoding parameters; and
transmitting the encoded multimedia data to the user-end device for decoding thereat.

13. The method of claim 12, wherein dynamically adjusting encoding parameters includes:
establishing a parameter adjustment table; and
comparing the network status message and the parameter adjustment table to obtain the encoding parameters corresponding to the network status message.

14. The method of claim 12, wherein dynamically adjust encoding parameters is performed through a learning mechanism.

15. The method of claim 14, wherein dynamically adjust encoding parameters through the learning mechanism comprises:
establishing a parameter learning model;
inputting the network status message into the learning model by the user end device; and
adjusting the encoding parameters by the data server according to the parameter learning model.

16. The method of claim 12, wherein the user-end device sends the network status message back to the data server through a Real-Time Control Protocol (RTCP) feedback mechanism.

17. The method of claim 12, wherein the user-end device is a workstation, a desktop computer, a notebook computer, a personal digital assistance or a mobile phone.

18. The method of claim 12, wherein the user-end device generates the network status message by monitoring and analyzing at least one of network bandwidth, bandwidth fluctuation rate, packet loss rate, packet delay, delay jitter, bit error rate, receiving signal strength indication (RSSI) and network traffic of wired/wireless network channels.

19. The method of claim 12, wherein the encoding parameters comprise quantization, group of picture size, frame size and frame rate.

20. The method of claim 12, wherein an encoding format for the multimedia data is MPEG-1, MPEG-2, MPEG-4, WMV, AVI, H.261, H.263, H.264, Y4M or YUV.
